(19) United States
(12) Patent Application Publication
(10) Pub. No.: US 2012/0068497 A1
(43) Pub. Date: Mar. 22, 2012

(54) FIBER-WRAPPED, MAGNESIUM TUBULAR STRUCTURAL COMPONENTS

(75) Inventors: Hamid G. Kia, Bloomfield Hills, MI (US); Aihua A. Luo, Troy, MI (US); John N. Owens, Franklin, MI (US); James F. Quinn, Troy, MI (US)

(73) Assignee: GM GLOBAL TECHNOLOGY OPERATIONS, INC., DETROIT, MI (US)

(21) Appl. No.: 12/886,632

(22) Filed: Sep. 21, 2010

(51) Int. Cl. B60R 19/03; F16L 9/14

(52) U.S. Cl. 296/187.03; 138/153; 138/145; 138/141

(57) ABSTRACT

Magnesium alloy tube members have the potential to reduce weight in automotive vehicle body structures and other applications but they tend to fragment and fail under compressive stress loads applied end-to-end along the longitudinal axis of the tube. It is found that, when the outside surface of the tube is tightly wrapped with fibers (for example, glass fibers or other suitable fibers) and, optionally, resin bonded to the tube surface, the capacity of the magnesium alloy tube to withstand and absorb compressive loads is greatly increased.

### TECHNICAL FIELD

This invention pertains to the reinforcement of magnesium-based alloy tubular structural components for increased energy absorption, especially in compressive loading along the axis of the components. More specifically, this invention pertains to fiber wrapped, magnesium alloy tubes. Such tubes display a markedly increased capacity for energy absorption in sustaining impacts to vehicle bumpers, for example, and in other vehicle structural components intended for absorbing compressive loads or impacts.

### BACKGROUND OF THE INVENTION

There is a continual need to reduce the mass of vehicle components for improved fuel efficiency. And there is a continual need to adapt magnesium alloys for applications as reduced weight components in vehicle applications.

It is an object of this invention to adapt tubular components formed of magnesium-based alloys for increased energy absorption, especially when the component is intended to be subjected to compressive loads along the longitudinal axis of the tube structure.

### SUMMARY OF THE INVENTION

It is contemplated herein that a pair of tubes formed of a magnesium alloy might be used in an energy-absorbing application while supporting, for example, a front-end vehicle bumper. In many embodiments, the tube may be cylindrical or steeply conical (truncated) in cross-section so as to receive compressive loads. A bumper could be attached to, and carried by, the front-facing ends of a pair of spaced and horizontally-aligned, equal-length, round tubes, while the rear ends of the tubes are fixed to a vehicle body structure. A suitable bumper member would be positioned on the tubes to receive, for example, a relatively low speed impact that would otherwise damage adjacent body portions of the vehicle. In such tube-bumper arrangements, the tubular members are designed to receive a sudden compressive load along the axis of the tube (with possible deformation) and to absorb much of the energy of such an impact. The tube may experience some deformation under the axial compressive load, but it is intended that it will retain enough of its original shape to avoid damage to adjacent vehicle panels or other structures. However, the inventors herein have found that when extruded magnesium alloy (AZ31 alloy) tubes are subjected to such compressive loads, the magnesium metal tends to fragment pervasively, shattering the tube, rather than absorbing the load with some limited deformation. This kind of shattering of the tubes occurred even when round magnesium alloy tubes were extruded with integral, internal, radial strengthening ribs.

It is found that the energy absorbing capability of a magnesium alloy tube may be significantly increased by securely wrapping the outer circumference of the tube (or perimeter, when the tube is not round) with fibers, preferably glass fibers, in a wrapping pattern that reinforces the tube from outward fragmentation when the ends of the tube are abruptly compressed along its longitudinal axis. In general, it is preferred that the fibers are wrapped in tight, compressive contact with the outer surface of the tube and attached to the surface of the tube. It is found that such a fiber wrapping permits the magnesium tube to be subjected to much larger compressive loads before the tube fails or is severely damaged.

Glass fibers, or other non-metallic fibers, are sometimes preferred as the wrapping material as they do not cause galvanic corrosion of the magnesium alloy tube in most environments in which the tube would be expected to serve. Glass fibers are relatively inexpensive and are available in braided or woven layers, suitable for stretching around and against the outer surface of a tubular structure and tightening and bonding to the surface. In other embodiments, continuous glass fibers may be wound around the tube outer surface in bands spaced along the axis of the tube or in coextensive layers, from end to end of the tube. In some embodiments, the fibers may be coated with a suitable thermoplastic or thermosetting polymeric material (sometimes referred to herein as a resin) before, during, or after wrapping, for polymeric resin bonding of the wrapping to the tube surface. Sometimes the polymer may be used to isolate the fibers from the surface of the magnesium tube to avoid corrosion. In other embodiments, the fibers, or the ends of the fibers, may be fused or otherwise bonded to the outer surface of the tube to fix the fibers in place. The fibers may be wound so as to apply continual tension about the external surface of the tube. In other cases, the fiber wrapping will be applied to resist outward deformation of the tube when it is loaded in compression along its longitudinal axis.

Magnesium alloy tubes are often round cylinders with a longitudinal axis, but they may be prepared in other cross-sectional configurations, such as square, rectangular, or in other polygonal shapes. Also, the tube may be in the shape of a truncated cone with varying cross-sections. Often, a conical tube for use as a compression member will have suitably steep sides for absorbing the compressive force along the vertical axis of the tube. The magnesium alloy tube may have internal stiffening members to reduce the tendency of the tube to collapse inwardly when subjected to an axial compressive load. Such tubes are often extruded, but they may be formed by other methods, such as by casting, or by shaping from sheet metal precursor shapes.

These and other objects and advantages of the invention will be apparent from a detailed description of some examples of embodiments of the invention. In these examples reference may be had to illustrative drawings which are described in the following section of this specification.

### BRIEF DESCRIPTION OF THE DRAWINGS

FIG. 1 is an oblique view of a magnesium alloy tube with a wrapping of epoxy resin bonded, glass fiber braid on its outer surface. In this illustration, the magnesium alloy tube also has four internal radial struts.

FIG. 2 is a graph of curves of data of compressive stress, in MPa, versus compressive strain, comparing data for a glass fiber braid covered magnesium alloy tube, as illustrated in FIG. 1, with an un-coated magnesium alloy tube of like shape and composition.

FIG. 3 is a bar graph of Energy Absorption (kJ) at failure, comparing data for a glass fiber braid covered magnesium alloy tube, as illustrated in FIG. 1, with an un-coated magnesium alloy tube of like shape and composition.

### DESCRIPTION OF PREFERRED EMBODIMENTS

As described above in this specification, magnesium and magnesium alloys offer extensive mass savings, but structural members formed of magnesium-based alloys often do not have an acceptable crush performance. Sometimes the tubes are intended to be loaded slowly; sometimes the tubes will be subjected to a sudden impact, such as tubes serving as vehicle bumper supports or vehicle body members that may receive a crash impact. It is found that such magnesium-based alloy tube structures don't deform as their original unitary piece, they tend to fragment and fail abruptly. In order to overcome this problem, and in accordance with this invention, tubular magnesium components are wrapped with fibers that retard or prevent the fragmentation of a magnesium structural member or article during a crash impact or other compressive loading.

The magnesium tubes may be formed in a variety of shapes for receiving a compressive load along the axis of the tube. Many tubes are formed with cylindrical inner and outer surfaces in shapes recognized as round (circular), square, rectangular or as other polygon shapes, or the like. Other tubes may have truncated conical shapes with a broad range of cross-sections. This invention is applicable to magnesium alloy tube structures generally, having two ends spaced on a substantially straight axis, and designed to be subjected to a compressive force applied against one end of the tube and transmitted toward the other end.

The magnesium tube may have internal ribs or struts for resisting inward deformation of the tube during a compressive load. Such internal reinforcing members will typically be straight, extend through the axis of the tube, and with opposing ends fixed to the internal surface of the tube. The internal reinforcing members may extend the full length of the tube or be fanned in selected longitudinal regions of the tube.

The external surface of the tube is wrapped with fibers for the purpose of supporting a compression loaded magnesium tube against fragmentation or other failure of the tubular structure. The fibers may be glass fibers, carbon fibers, or the like. The fibers may be metal fibers. Glass fibers are often preferred because they are strong, relatively inexpensive, available in many forms, and do not tend to corrode the magnesium tube in most working environments. Continuous fibers (sometimes called “roving”) may be wound around the tube in a generally helical pattern. The wrapping is to reinforce the full length of the tube. However, continuous fiber wrappings may be applied in circumferential bands spaced along the length of the tube. Many fibers, such as glass fibers, are available in braided or woven cloths that may be wrapped around the outer surface of the tube to support the tube under compressive loads. The fiber wraps are fixed to the tube surface.

The ends of many fiber materials may be fused or otherwise simply attached to the outer surface of the magnesium tube to suitably anchor the fiber wrapping for its intended supportive role. However, in many embodiments of the invention, the fibers are coated with a suitable polymeric material, either before or after wrapping, and the polymer hardened or cured so that the fibers are embedded in the polymer as part of a composite wrapping. The polymer coating is suitable for virtually any fiber wrapping, and may be necessary for certain metal fibers to isolate them from corrosion-inducing contact with the magnesium tube surface.

Fiber wrapped, magnesium tubes will find many useful applications, where relatively light-weight structural members are needed to sustain compressive loads, especially sudden compressive loads. In automotive vehicles, for example, such magnesium tubes may be used to attach bumpers to vehicle body members where the tubes are intended to absorb crash impacts. In fact, such tubes are sometimes called “crash cans.” Fiber wrapped magnesium tubes make lighter weight crash cans than the heavier metals now required. Also, fiber wrapped magnesium tubes may be used as other vehicle body or chassis members that are shaped and located to receive sudden crash impacts, or the like.

### Illustrative Example

The following example is intended to illustrate a combination of several elements of the invention. It is to be understood that not all of the illustrated elements may be necessary or desirable in other applications for fiber wrapped structural magnesium tubes. Alternatively, other combinations of wrappings and tube shapes may be used.

In accordance with an illustrative practice of this invention, extruded AZ31 magnesium alloy, round cylindrical tubes with four radial internal reinforcing struts, spaced at 90° of arc, were over-molded using a glass fiber braided layer and an epoxy resin. AZ31 magnesium alloy comprises, by weight, nominally, about three percent aluminum, one percent zinc, and the balance substantially magnesium. The glass fiber braid coated tubes and like uncoated magnesium alloy tubes were subjected to compression loading along their respective cylinder axes. The result was more than 300% improvement in energy absorption of the glass fiber braid and epoxy resin over-molded magnesium tubes.

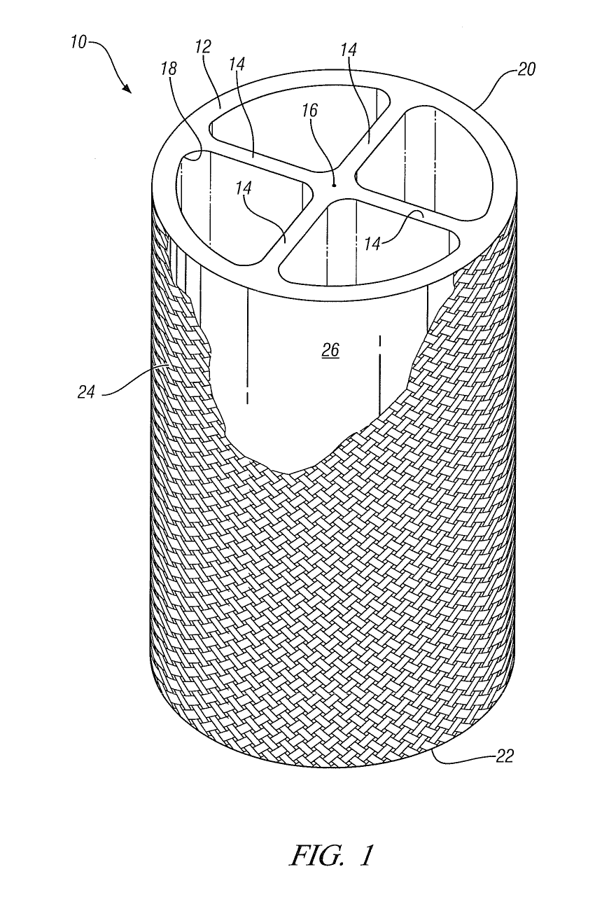

FIG. 1 presents an illustration of, for example, an extruded AZ31 alloy tube 10 such as might be used as one of two (or more) crash can members for attachment at one of their tube ends to the front end of a vehicle body structure and for carrying a bumper structure attached to their opposite tube ends. Magnesium alloy struts (or crash cans) of this type are lighter in weight than other metal struts and may be used, for example, to carry relatively light weight bumper structures formed of energy absorbing polymer and polymer composite materials.

FIG. 1 illustrates an extruded, round, cylindrical tube 10 of AZ31 alloy, representative of magnesium alloy tubes selected for evaluation of their capacity to absorb compressive loads, such as in vehicle body structures. Extruded tube 10 is about 546 millimeters in length with an external diameter of about 50.8 mm. The thickness of the tube wall 12 is uniformly about 3.5 mm. In this illustration, extruded tube 10 has four internal radial struts 14 (or two diametrical struts), spaced at 90°, and that extend from the center 16 of tube 10 to the inside surface 18 of the tube 10. Each of struts 14 (about one inch in radial length) extends like a rib or wall along the full length of the tube 10. The radial struts 14 are intended to provide reinforcing strength to the tube 10 structure, including support to resist internal collapse of tube 10 when a compressive load is applied between tube ends 20, 22 and along the longitudinal axis of the tube, passing through tube center 16.

Tube 10 in FIG. 1 has a braid 24 of strands of grouped glass fibers stretched into engagement with the external surface 26 of tube 10. Glass fiber braid 24 is impregnated with epoxy resin and bonded to surface 26 by the resin in its cured or dried state. This resin bonded, glass fiber braided wrap provides reinforcement to tube 10, especially, but not solely, when the tube is subjected to an end-to-end compressive load. In one illustration, the epoxy resin bonded, glass fiber braid 24 was applied to tube 10 as follows.

In this illustration, an extruded, 50.8 mm external diameter, 546 mm long, AZ31 magnesium alloy tube (as illustrated in FIG. 1) was cleaned with an acetone wipe. A fiberglass round braid from A&P Technology (#Z24L300R, nominal 3″ diameter, 18 oz/yd²) was cut to a length of 19″ (mass of 54.5 g). The fiberglass braid was pulled over the outer surface of the magnesium tube and then tensioned longitudinally to pull the braid snug to the tube. The braid was taped to the magnesium tube at the ends of the tube to maintain the tensioning on the glass fibers.

Based on the mass of the fiberglass braid, the desired mass of resin was 27.3 g (approximately ½ of the mass of the fiberglass braid). An excess of epoxy resin was needed to allow for some resin to flow past the end of the braided section and into the bleeder cloth.

Forty grams of an epoxy resin was mixed at room temperature. The formulation of the resin was based on a 100 parts epoxy resin (Dow 383), 80 parts anhydride curing agent (MTHPA 600 from Lonza), and 2 parts of a catalyst (BDMA from Aldrich). The resin was hand mixed and degassed for 10 minutes. The glass fiber braid-wrapped tube was placed on a sheet of release film and the epoxy resin was poured and hand spread over the central two thirds of the overwrapped fiberglass braid. Bleeder cloth was taped to the ends of the braid. The tube with its over-braid layer was then wrapped with the release film, then bleeder cloth, and finally an outer layer of a vacuum bagging film. After sealing the bag, a vacuum was applied and the whole bagged tube was placed into an oven at 80 C. The tube was left in the oven for approximately 3 hours to cure. After the epoxy resin was cured the protective bag was removed. A number of the fiber glass braid composite coated magnesium alloy tubes were prepared by this hand process.

Comparative compression loading tests were performed, both on bare (no fiber glass wrapping) magnesium alloy tubes as described above, and epoxy resin-bonded, glass fiber braid-covered magnesium alloy tubes, prepared as described above. In each test, a tube was placed standing vertically on one end on a supporting surface and a compressive load was applied to the upper end. The loading was applied evenly over the round upper end of the tube and directly along the vertical central axis of the up-standing tube. The compressive load was programmed and applied so as to increase and defoini each tube downwardly at a rate of one millimeter per second. It was observed that the uncoated magnesium tubes soon fragmented pervasively and collapsed. But the magnesium alloy tubes that were wrapped in the resin bonded glass fiber braid withstood a much greater compressive loading.

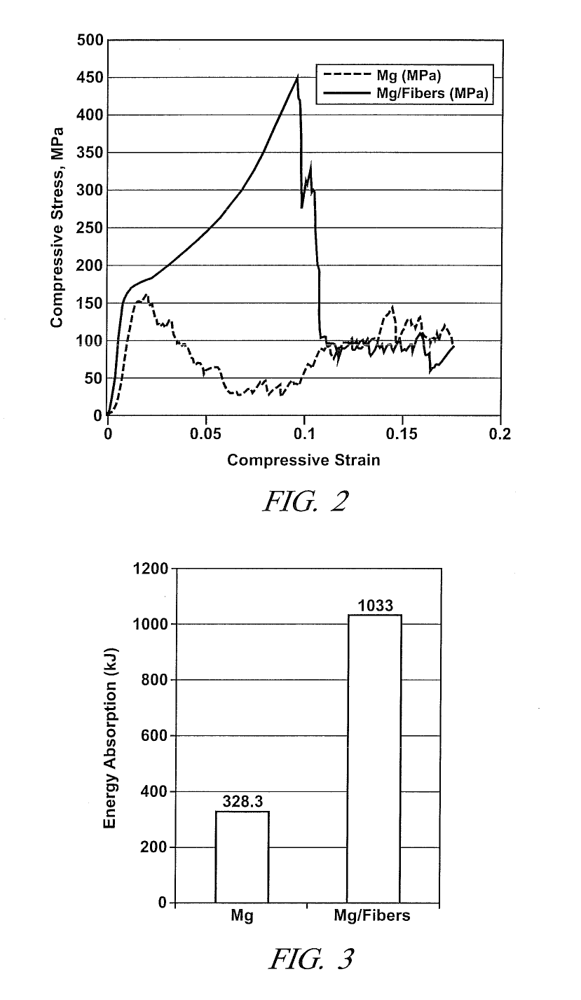

Data from the compressive tests is summarized in the graphs of FIG. 2 and FIG. 3. It is seen in the data of FIG. 2 that the bare magnesium alloy tubes failed at a compressive stress of about 150 MPa after experiencing a compressive strain of about 0.02. The glass fiber braided magnesium alloy tubes failed under a compressive stress of about 450 MPa and a compressive strain of almost 0.1. Thus, the resin bonded, glass fiber braided magnesium alloy tubes were able to sustain a compressive stress, before they failed, that was three-times the compressive stress of the uncoated magnesium tubes at their failure.

FIG. 3 presents energy absorption data (KJ) for the bare magnesium tubes and the glass fiber braided magnesium alloy tubes. As reported in FIG. 3, the energy absorption of the fiber coated tubes was more than three times that of the bare tubes.

The intended function of the fiber wrapping of the magnesium tubes is to ensure that the magnesium tube structure is sustained in the compressive load path along the central axis of the tube structure and absorbs the applied energy. The hand-applied glass braid wrapping of the extruded AZ31 magnesium alloy tubes was considered very effective and successful in attaining this goal.

The above example of preparing the glass braid wrapped magnesium alloy tube used a hand lay-up process because only a few tubes were wrapped. However, the application of the fibers to the outer perimeter of the tubular structure can be accomplished by any of a number of other well known and higher production techniques. The intended result of the application of the fibers is for the fibers to support the underlying magnesium tube against an axial compressive force.

For example, the fibers may be braided into a sleeve which can be subsequently pulled over the tube as was described in the above illustrative example In the case of an extruded magnesium tube, the braiding machine could be designed to braid directly onto the emerging extruded tube in a continuous process.

In another process, the tube may be wrapped via filament winding in which a strand of fibers is wound around a rotating tube with the angle of winding controlled by the position of a machine controlled eyelet.

The fibers may also be placed over the tube with fiber tape winding which is similar to filament winding but, instead of a single filament or strand, a thin width of tape is wound around the rotating tube. The tape could be composed of unidirectional fibers or of a woven or braided collection of fibers that has been slit to an appropriate width for winding. There are variations of filament winding in which the tube is held stationary and the winding eyelet rotates about the tube axis.

The tubes may also be roll wrapped. In this process, a pre-cut rectangular piece of a woven fabric is attached to the tube along one edge and then the tube is rotated along its axis until the entire fabric has wrapped itself around the tube.

In any of the above described fiber application processes, the fibers can be applied either “dry” (without substantial polymeric resin) or “wet” (with an infusion or coating of polymeric resin). In the case of the “dry” fiber application, and where the fibers are not directly bonded to the tube, a secondary process would be needed to apply the polymeric resin followed by a consolidation and curing step. In the case of the “wet” fiber application, only the consolidation and curing steps would be required.

Because the function of the polymer composite is to ensure the magnesium remains in the load path and absorbs the applied energy, a variety of resins and fibers can be used for this purpose. In the above illustrative example, a thermosetting epoxy resin formulation was applied to braided glass fibers. But in other embodiments it may be preferred to use a thermoplastic polymer material. For instance, thermoplastic polymer coated glass fibers (or other fiber materials) may be wrapped around a magnesium tube to form the restraining composite. For example, a glass roving such as PPG HYBON 2001 coated with a thermoplastic resin such as polypropylene may be used. During wrapping, the tube is kept at a suitable elevated temperature so that the polymer coating is sufficiently mobile for consolidation of the wrapped fibers. In another example, a suitable phenolic composition, such as PLENCO phenolic resin, may applied to the glass fibers in a filament winding process.

Accordingly, the type of resin, the type of fibers, the orientation and distribution of the fibers in the composite layer all have to be optimized, based on experimentation or experience, and based on the magnesium tubular component geometry and its application as well as the load direction.

One embodiment of the invention was illustrated with a round cylindrical tube formed by extrusion using an AZ31 magnesium alloy. Tubes may be formed with other cross-sectional shapes. For example, they may be cylindrical or conical, or have other suitable structural shapes. They may be square, polygonal, or take other shapes in the generation of a relatively thin wall tube with complementary inner and outer wall surfaces. Such tubes may be formed of other magnesium alloys adapted for the casting of tubes or for the shaping of tubes from sheet materials or the like.

Accordingly, while practices of the invention have been illustrated with some specific examples, it is to be understood that the scope of the invention is not limited to these illustrative examples.

1. A tube formed of a magnesium-based alloy and having a length and longitudinal axis, an internal tube surface and a complementary external tube surface spaced from the internal surface to define a tube wall, and opposing end surfaces spaced along the longitudinal axis of the tube;
the tube being sized and shaped to serve as a structural member for receiving a compressive stress applied to an end of the tube and acting along the axis of the tube toward the opposing end of the tube; and
the tube further comprising fibers wrapped around the external surface of the tube, from end to end, the fibers being wrapped to apply a restraining force on the external surface of the tube for resisting fragmentation of the tube by the compressive force applied to the end of the tube; and
the wrapped fibers being attached to the external surface of the tube.

2. A tube as recited in claim 1 in which the wrapped fibers are coated with a polymeric resin and resin-bonded to the external surface of the tube.

3. A tube as recited in claim 1 in which the tube has at least one rib extending through the axis of the tube and fixed to the internal surface of the tube to reduce deformation of the tube by the compressive force applied to the end of the tube.

4. A tube as recited in claim 1 in which the wrapped fibers are metal fibers and the wrapped metal fibers are separated from the surface of the magnesium tube by a coating of polymeric material.

5. A tube as recited in claim 1 in which the wrapped fibers are glass fibers.

6. A tube as recited in claim 1 in which the wrapped fibers comprise glass fibers that are coated with a polymeric resin and bonded to the tube surface with the resin.

7. A tube as recited in claim 1 in which the wrapped fibers are glass fibers, wrapped in the form of braided or woven fibers.

8. A tube as recited in claim 1 in which the wrapped fibers are glass fibers, wrapped in the form of braided or woven fibers, coated with a thermosetting resin and bonded to the tube external surface with the resin.

9. A tube as recited in claim 1 in which the wrapped fibers are continuous glass fibers that are wrapped around the tube external surface in a continuous layer from one end of the tube to the other end.

10. A tube as recited in claim 1 in which the wrapped fibers are continuous glass fibers that are coated with a polymeric resin and are wrapped around the tube external surface in a continuous layer from one end of the tube to the other end.

11. A tube as recited in claim 1 in which continuous glass fibers are wrapped to form a series of spaced bands of fibers on the external surface of the tube, the fibers being wrapped around the axis of the tube such that the bands lie generally parallel to the ends of the tube.

12. A tube as recited in claim 1 in which resin-coated continuous glass fibers are wrapped to form a series of spaced bands of resin bonded fibers on the external surface of the tube, the fibers being wrapped around the axis of the tube such that the bands lie generally parallel to the ends of the tube.

13. A tube as recited in claim 1 in which the tube is a round or polygonal cylinder in cross-section.

14. A tube as recited in claim 1 in which the tube is a truncated cone with a round or polygonal cross-section.

15. A tube as recited in claim 3 in which the tube is round and has two diametrical ribs spaced at ninety degrees of arc.

16. A tube as recited in claim 1 in which the wrapped fibers are bonded to the external surface of the tube with an epoxy resin.

17. A tube as recited in claim 1 in which resin-bonded, wrapped fibers extend from one end of the tube to the other, covering substantially the whole external surface of the cylinder.

18. A tube as recited in claim 1 in which epoxy resin bonded wrapped fibers extend from one end of the tube to the other, covering substantially the whole external surface of the cylinder.

19. A tube as recited in claim 1 when serving to absorb compressive impacts on a vehicle bumper.

20. A tube as recited in claim 1 when serving to absorb compressive impacts on a vehicle body.
